(19) United States
(12) Patent Application Publication
(10) Pub. No.: US 2009/0301327 A1
(43) Pub. Date: Dec. 10, 2009

(54) Stamping Tool

(75) Inventors: Douglas Nelson, Madison, WI (US); Rebecca Lidstrom, Madison, WI (US); Julia Dorn, Sun Prairie, WI (US); Peter Russo, Bedford, MA (US); William Cooke, Warwick, RI (US); Carl Dana Hardy, Medfield, MA (US)

Correspondence Address: FOLEY & LARDNER LLP, 321 NORTH CLARK STREET, SUITE 2800, CHICAGO, IL, 60654-5313, US

(73) Assignee: Fiskars Brands, Inc.

(21) Appl. No.: 12/467,840

(22) Filed: May 18, 2009

Related U.S. Application Data
(60) Provisional application No. 61/060,387, filed on Jun. 10, 2008.

(51) Int. Cl. B41K 1/42

(52) U.S. Cl. 101/333

(57) ABSTRACT

A self-inking hand stamp tool for generating a stamp on a surface. In an embodiment, the self-inking hand stamp tool comprises a base, a carriage operatively coupled to the base, a stamp operatively coupled to the carriage, an inkpad operatively coupled to the base, and a housing operatively coupled to the base, wherein operation of the housing transfers the stamp from an inking orientation to a stamping orientation. The stamp may further comprise a stamp plate selectively couplable to the carriage and one or more stamp sheets selectively adherable to the stamp plate. In an embodiment, the one or more stamp sheets are selectively adhered to the stamp plate via an electrostatic force.

### CROSS REFERENCE TO RELATED PATENT APPLICATIONS

The present application claims priority to U.S. Provisional Patent Application No. 61/060,387, filed Jun. 10, 2008. The contents of this application are incorporated herein by reference in their entirety.

### FIELD OF THE INVENTION

The present invention relates generally to the field of hand stamp tools for generating a stamp on a surface. More particularly, the present invention relates to self-inking hand stamp tools with interchangeable stamps.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Various conventional hand stamp tools for generating an ink message on a surface such as paper and other materials are known. Such hand stamp tools have been employed to stamp surfaces with an identical message such as an address, message, or phrase such as “RECEIVED,” “PAID,” or other term or symbol. These systems generally comprise a housing assembly and a stamp operatively coupled to the housing assembly. The stamp is deployed and engages the surface to be stamped when an operator depresses the top of the housing. Such hand stamp tools may require the stamp be applied to a separate ink reservoir periodically to refresh the stamp surface with ink so that a legible stamp may be generated on the surface.

Other conventional hand stamp tools are self-inking. These hand stamp tools integrate the ink reservoir with the housing assembly. One such type of hand stamp tool slidingly and rotatably couples the stamp to the housing assembly. The stamp surface engages the ink reservoir when the hand stamp tool is not in use. When an operator depresses the top of the housing assembly, the inked stamp translates downwardly away from the ink reservoir, rotates about 180 degrees, such that the stamp surface is opposed with the surface to be stamped, and continues its downward translation until the stamp engages the surface.

Typically, the above described conventional hand stamp tools can only produce a single established message, phrase, term, or symbol that on a surface. Thus, one may need to obtain, store, and maintain a collection of hand stamp tools having an assortment of the stamps with various messages, phrases, etc. Other conventional stamp tools have sought to address this deficiency by implementing a coupling a plurality of rotatable stamp wheels to the housing. Such stamps are generally limited to stamping a series of numbers such as dates and serial numbers. Still other conventional systems employ a stamp pad that is selectively coupled to the housing assembly. However, the stamps may be bulky and such systems are still constrained in that they are limited to a finite set of prefabricated stamps. Still other systems require an operator to assemble a plurality of characters into predefined slots or holes in a stamp pad substrate to form the desired stamp. However, this process can be inefficient and may require an operator to precisely manipulate onto the substrate, what are often very small stamp elements that may be covered in residual ink. Moreover, such systems are still limited because the stamp elements can usually only be assembled to the substrate at predefined locations. Thus, there is a need for a flexible hand stamp tool that permits use of prefabricated stamps but also allows for convenient and efficient creation of operator definable stamps.

### SUMMARY OF THE INVENTION

Various embodiments of the present invention comprise a flexible self-inking hand stamp tool. Embodiments of the hand stamp tool are configured to permit efficient exchange and installation of various stamps. Further, custom stamps may be created for use with the hand stamp tool by arranging one or more various stamps on the stamp tool.

In one set of embodiments, a self-inking hand stamp tool comprises a base, a carriage operatively coupled to the base, a stamp operatively coupled to the carriage, an inkpad operatively coupled to the base, and a housing operatively coupled to the base, wherein operation of the housing transfers the stamp from an inking orientation to a stamping orientation. The stamp may further comprise a stamp plate selectively couplable to the carriage and one or more stamp sheets selectively adherable to the stamp plate. In an embodiment, the one or more stamp sheets are selectively adhered to the stamp plate via an electrostatic force.

Embodiments of the present invention allow for the efficient creation of a custom stamp for use with a hand stamp tool. Various stamp sheets may be selectively adhered to the stamp plate for use with the stamp tool. The stamp sheets may comprise stamps of messages, phrases, words, characters, symbols, designs, or other indicia, and combinations thereof. By combining these various stamp sheets as desired on the stamp plate, a customized stamp may be created and used with the hand stamp tool. In an embodiment, the stamp sheets are selectively adhered and retained on the stamp plate by way of electrostatic attractive force between the stamp sheets and the stamp plate. Embodiments of the hand stamp tool are flexible in that they conveniently permit the exchange and ready creation of stamps for use in a self-inking hand stamp tool.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1A is a perspective view of one embodiment of the stamp tool of the present invention showing a base, a carriage, and a housing, FIG. 1B is a front plan view of the stamp tool of FIG. 1A, and FIG. 1C is a side plan view of the stamp tool of FIG. 1A;

FIG. 2 is an exploded view of the stamp tool of FIG. 1A;

FIG. 3 is a second exploded view of the stamp tool of FIG. 1A further showing a stamp plate, an inkpad, a inkpad housing, and a base gasket;

FIG. 4A is a perspective view of the stamp plate of FIG. 3, and FIG. 4B is a front plan view of the stamp plate of FIG. 4A;

FIG. 5 is a perspective view of the stamp plate of FIG. 4A further showing a stamp sheet;

FIG. 6A is an exploded view of an inkpad assembly showing the inkpad and the inkpad housing of FIG. 3 and further showing an inkpad cover, FIG. 6B is a side view of the inkpad assembly of FIG. 6A, and FIG. 6C is a top view of the inkpad assembly of FIG. 6A; and

FIG. 7 is an exploded view of another embodiment of the inkpad assembly of FIG. 6A.

### DETAILED DESCRIPTION OF EMBODIMENTS

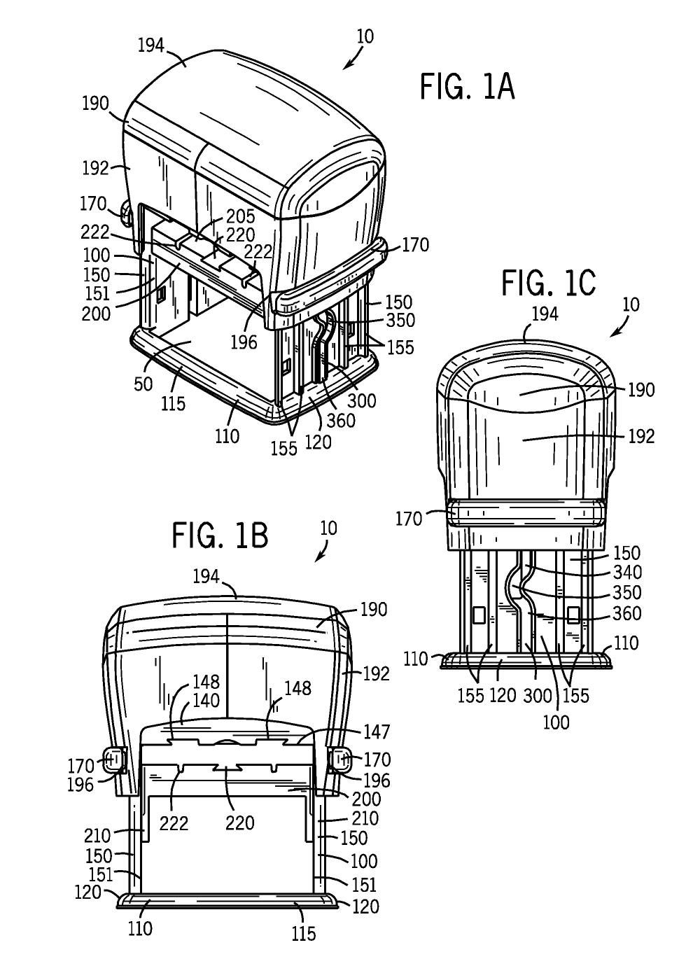

With reference to FIGS. 1A, 1B, and 1C, a stamp tool 10 constructed in accordance with an embodiment of the present invention is depicted. The stamp tool 10 comprises a base 100, a cover 190 operatively connected to a base 100, and a carriage 200 operatively connected to the base 100.

The base 100 generally comprises a open box-like structure constructed from a bottom member 110, a pair of side walls 150 extending upwardly from the bottom member 110, and a top member 140 operatively connected to the pair of side walls 150 and substantially parallel and opposite the bottom member 110. The base 100 may be constructed from a single piece or multiple pieces of injection molded plastic or from other methods and or materials known in the art. If constructed from multiple pieces, the various structures may be configured for interlocking assembly and or securement with fasteners, or other techniques such as gluing or sonic welding.

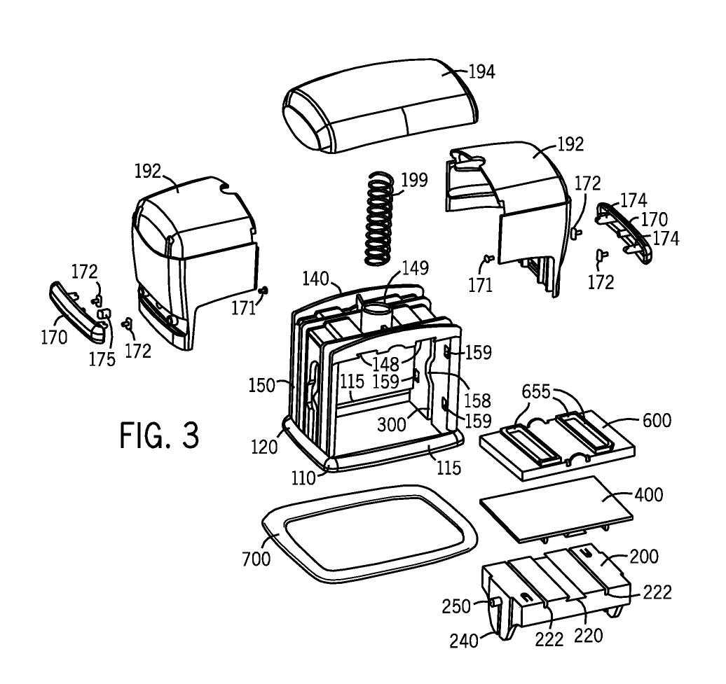

The bottom member 110 is configured for orientation of the stamp tool 10 over the surface a piece of material to be stamped, such as a sheet of paper, or a piece of cardboard, wood, fabric, or other material. The bottom member 110 generally comprises a open frame-like structure formed by a pair of lateral members 115 a pair of end members 120. The pair of lateral members 115 and the pair of end members 120 define a stamp area 50. The stamp area 50 is sized such that the stamp tool 10 may fashion a stamp on the underlying material as typically practiced in the art. For example, in an embodiment, the pair of lateral members 115 are each about 135 mm long and the pair of end members 120 are each about 100 mm long. The pair of lateral members 115 and the pair of end members 120 are operatively connected such that the bottom member 110 comprises a substantially planar bottom surface for placement of the base 100 on the surface of the material to be stamped. Optionally, a base gasket 700, as depicted in FIG. 3, may be provided as an alignment guide. The base gasket 700 generally comprises a relatively thin rectangular frame with an open internal region. The base gasket 700 is configured such that the bottom member 110 of the stamp tool 10 nests within the open internal region or operatively couples or rests substantially on a perimeter of the base gasket 700. The base gasket 700 may be initially placed on the surface for alignment. Once the base gasket 700 is aligned as desired, the stamp tool 10 may be placed in relation to the base gasket 700 for stamping operations. The base gasket 700 may comprise a substantially rigid material, including plastic. In other embodiments, the base gasket 700 may be semi-rigid and comprise a polymer or rubber material with a relatively high coefficient of friction to mitigate slippage between the base gasket 700 and the underlying material to be stamped and or the stamp tool 10.

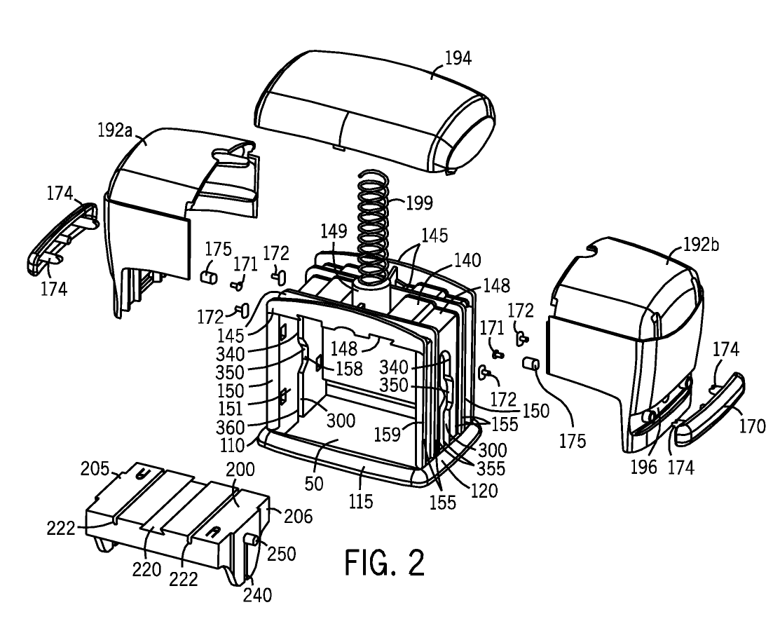

With reference to FIGS. 1A, 1B, and 1C, the pair of side walls 150 are operatively connected to the pair of end members 120 and extend substantially normal from the base 100. The pair of side walls 150 may include reinforcing members such a rib 155 for increased rigidity and reliability of the stamp tool 10. A carriage guide 300 is disposed along a portion of each of the pair of side walls 150. The carriage guide 300 comprises a top portion 340, a turning portion 350, and a bottom portion 360. The top portion 340 and the bottom portion 360 are substantially co-linear channels orientated normal to the bottom member 110. Disposed between, and connecting the top portion 340 and the bottom portion 360, is the turning portion 350. The turning portion 350 is an arcuate channel projecting toward one of the pair of the lateral members 115. The carriage guide 300 may comprise a through slot, a recess, one or more rails, or other guiding feature. As seen in FIG. 2, the carriage guide 300 may be reinforced with a rib 355. A guide pin 158 is also disposed on an inner surface 151 of each of the pair of side walls 150. As depicted in FIG. 2, the guide pin 158 is disposed approximately in line with the top portion 340 and bottom portion 360 and proximate the turning portion 350.

The top member 140 is disposed opposite to the bottom member 110 and spans between the pair of side walls 150. The top member 140 is substantially parallel to the bottom member and substantially normal to the pair of side walls 150. The top member 140 includes an inner surface 147. One or more engagement features 148 may be disposed on the inner surface 147. As seen in FIG. 2, the top member 140 may include reinforcing ribs 145 to enhance rigidity. Also, the top member 140 may include a retaining feature 149 configured to receive a biasing member 199.

The cover 190 generally comprises a five-sided box that is slidingly received over a portion of the base 100. The cover 190 is operatively connected to the base 100. The cover 190 comprises a top surface 194 and a skirt 192 protruding downwardly from the perimeter of the top surface 194. The skirt 192 may be configured with guide features configured to operatively engage the side walls 150 and, in particular, the ribs 155/355. The cover 190 may be constructed from a single piece of material or multiple pieces of injection molded plastic or using other methods and materials. As seen in FIG. 2, the skirt 192 may comprises a left portion 192a and a right portion 192b. If constructed from multiple pieces, the various pieces of the cover 190 may be configured for interlocking assembly and or secured with fasteners or other techniques. A biasing member 199 may be disposed between the top member 140 and the top surface 194. In the depicted embodiment, when the biasing member 199 is in its relaxed orientation, it biases the cover 190 away from the top member 140. The biasing member 199 compresses when the cover 190 is selectively displaced downwardly toward the bottom member 110.

A recess 196 may be disposed on the external surface of the skirt 192, opposite the pair of side walls 150. The recess 196 is configured to at least partially slidingly receive a lock button 170. The lock button 170 is selectively displaceable from an extended orientation to a compressed orientation. A biasing member 175 disposed between the lock button 170 and the skirt 192 biases the lock button outwardly to the extended orientation. A fastener 171 operatively couples the lock button 170 to the skirt 192 and may retain the biasing member 175. One or more bosses 174 are disposed on the lock button 170 and extend inwardly. A locking tab 172 is operatively connected to each of the one or more bosses 174. The locking tab 172 is configured to slidingly engage one or more holes 159 disposed in each of the pair of side walls 150 when the lock button 170 is placed in the compressed orientation. As depicted in FIG. 2, the cover 190 may be locked in an upper orientation by compressing the lock button 170 to engage the locking tab 172 with the holes 159 disposed on an upper portion of the pair of side walls 150. The cover 190 may also be locked in a lower orientation by depressing and translating the cover 190 downwardly and compressing the lock button 170 to engage the locking tab 172 with the holes 159 disposed on a lower portion of the pair of side walls 150.

The carriage 200 is operatively coupled to the base 100. The carriage 200 is generally a rectangular block and comprises an engagement surface 205 and a side surface 206 extending normally from the engagement surface 205. A carriage axle 250 protrudes from the side surface 206 at each end of the carriage 200. The carriage axle 250 is slidingly received in the carriage guide 300 of the side walls 150. A carriage slot 240 is also disposed on the side surface 206 proximate the carriage axle 250. The carriage slot 240 may be a through hole, a recess, one or more rails, or other guide feature. The carriage slot 240 slidingly receives the guide pin 158. The carriage 200 and the base 100 are operatively connected via the above described features, which permit translation of the carriage 200 along the carriage guide 300 and rotation of the carriage 200 in relation to the base 100. In the top portion 340 of the carriage guide 300, the carriage 200 translates in a direction substantially normal to the stamp area 50. Upon reaching the turning portion 350, the carriage axle 250 and the guide pin 158 operate to cam the carriage 200 through a rotation of about 180 degrees. Thus, the engagement surface 205 is rotated from being generally upwardly facing, opposing the top surface 194 of cover 190, to downwardly facing, opposing the stamp area 50, and substantially planar with the stamp area 50.

The carriage 200 may further include one or more engagement features to operatively couple a stamp plate (not shown) to the carriage 200. As seen in FIG. 2, the engagement surface 205 of the carriage 200 includes a central female engagement feature 220 and may further include one or more peripheral female engagement features 222. The central female engagement feature 220, as depicted in FIG. 2, is of a dovetail configuration extending the width of the engagement surface 205. However, alternative geometry may be implemented. The peripheral female engagement features 222 is depicted as a pair of slots extending the width of the engagement surface 205. Again, alternative geometry, including dovetail arrangements, and other interfacing structures may be implemented here. Although the carriage 200 is depicted with female engagement features, the engagement features may be configured as male engaging features, mixed, or another type of engagement feature.

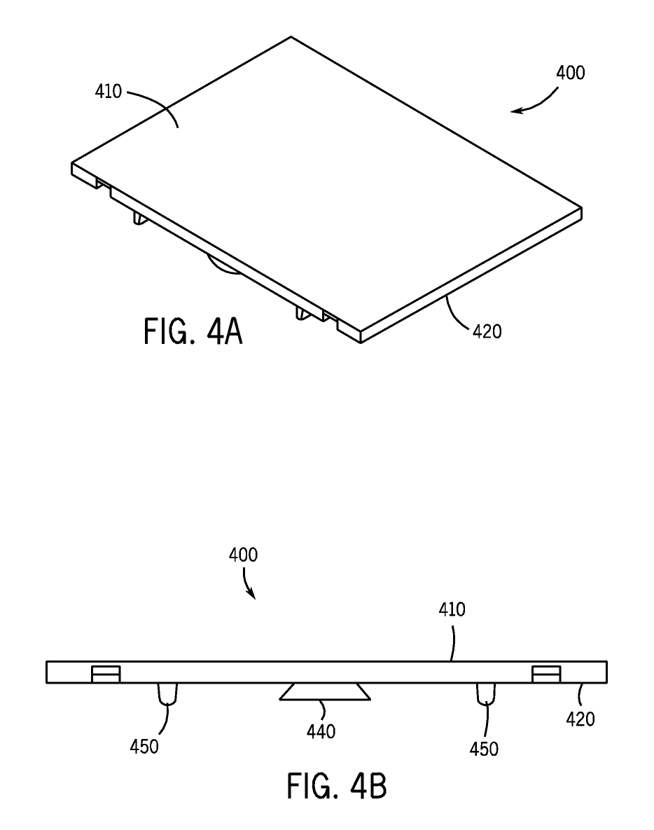

With reference to FIGS. 3, 4A and 4B, a stamp plate 400 is configured for selective attachment to the carriage 200. The stamp plate 400 generally comprises a rectangular plate with a stamp surface 410 and an engagement surface 420 disposed opposite the stamp surface 410. The stamp surface 410 is sized to correspond with the stamp area 50. In an embodiment, the stamp surface 410 is about 105 mm long and about 76 mm wide. Other embodiments are readily constructed to correspond with various sizes of stamp area 50 or to correspond to partial regions of the stamp area 50.

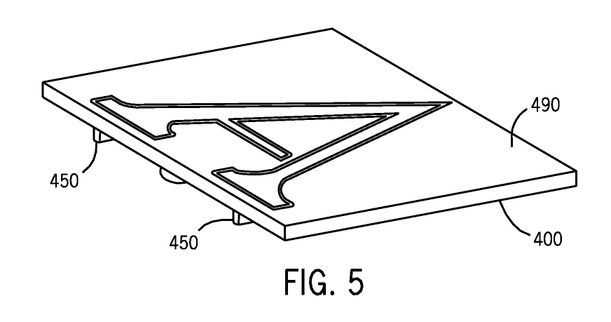

The stamp surface 410 may comprise a substantially planar surface with raised portions indicative of the stamped message, phrase, word, symbol, or otherwise to be stamped on the surface of the underlying material. Alternatively, the stamp surface 410 is a substantially planar surface adapted to receive one or more selectively attachable stamp sheets 490, as depicted in FIG. 5. In this configuration, various selectively attachable stamp sheets 490 with raised portions comprising messages, words, characters, figures, designs, and or combinations thereof may be selectively adhered to the stamp surface 410. The one or more selectively attachable stamp sheets 490 can be arranged as desired over any portion or the entirety of the stamp surface 410, providing a high degree of flexibility in creating and modifying stamps for use with the stamp tool 10.

In an embodiment, the one or more selectively attachable stamp sheets 490 are adhered to the stamp surface via an electrostatic attractive force between the inner surface of the one or more selectively attachable stamp sheets 490 and the stamp surface 410. Adhesion is accomplished by maintaining opposite electrical charges on the stamp surface 410 and the selectively attachable stamp sheets 490. For instance, the stamp surface 410 may have a positive charge while the selectively attachable stamp sheets 490 may have a negative charge. The oppositely charged surfaces are selectively adherable. The relative strength of the bond between the one or more selectively attachable stamp sheets 490 and the stamp surface 410 is proportional to the charge differential between the surfaces. The electrostatic force is sufficient to retain the selectively attachable stamp sheets 490 in their intended position during stamping operations. If necessary, a substantial negative charge can be developed on the selectively attachable stamp sheets 490 by repeatedly rubbing the inner surface on another nonconductive surface. It will be recognized that the charge orientations can be reversed such that the selectively attachable stamp sheets 490 have a positive charge and the stamp surface is provided with a negative charge. In an embodiment, the stamp surface 410 may be a substantially flat surface. When the stamp surface 410 is substantially flat, the stamp tool 10 may generally use a variety of stamps, such as selectively attachable stamp sheets 490; and it is not limited to stamps that are configured for a particular stamp tool 10 or stamp surface 410.

In the above described embodiment, the one or more selectively attachable stamp sheets 490 are readily adherable to and selectively removable from any portion of the stamp plate 400 by an operator. The one or more selectively attachable stamp sheets 490, as well as the stamp plate 400, may be constructed from plastic or other material adapted to retain an electrostatic charge sufficient to maintain adhesion of the respective surfaces, including acrylic, polystyrene, ABS, and polycarbonate. The materials may be substantially transparent. In an embodiment, the one or more selectively attachable stamp sheets 490 and the stamp plate 400 are constructed from substantially transparent acrylic.

The engagement surface 420 of the stamp plate 400 may include one or more engagement features configured to selectively and operatively connect the stamp plate 400 with carriage 200. The engagement features of the stamp plate 400 may be configured to engage corresponding features disposed on the carriage 200 such as the central female engagement feature 220 and the one or more peripheral female engagement features 222. In accordance therewith, FIG. 4B illustrates a central male engagement feature 440 and one or more peripheral male engagement features 450. The central male engagement feature 440 comprises a dovetail arrangement and is configured to slidingly engages the central female engagement feature 220. Similarly, the one or more peripheral male engagement features 450 are configured to slidingly engage the one or more peripheral female engagement features 222. The engagement features permit efficient exchange among a plurality of stamp plates, which may include different messages, words, characters, figures, designs, and or combinations thereof. Additionally, by decoupling the stamp plate 400 from the carriage 200, the stamp surface 410 is easily accessible for stamp creation with the one or more stamp sheets 490 and then re-coupled to the carriage 200 for operation. Thus, a high degree of flexibility is provided in using preexisting and efficiently creating custom stamps.

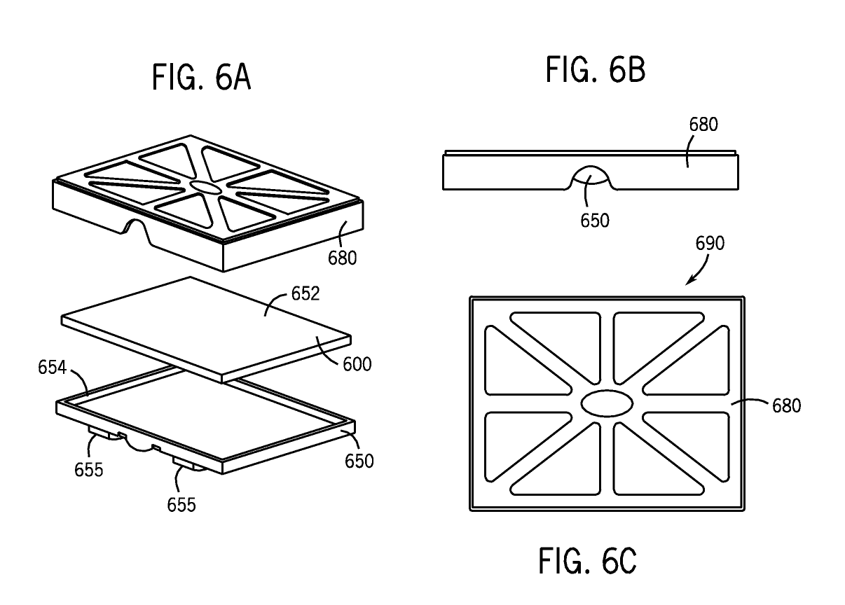

With reference to FIGS. 3, 6A, 6B, and 6C, an inkpad 600 configured for use with the stamp tool 10 is depicted. The inkpad 600 is operatively connected to an inkpad housing 650. The inkpad housing 650 generally comprises a five-sided box of a base surface 652 and a perimeter wall 654 extending substantially normal from the base surface 652. The inkpad 600 at least partially resides within the region bounded by the perimeter wall 654 and the base surface 652. The inkpad housing 650 may include engagement features configured to operatively couple the inkpad housing 650 and the base 100. As depicted in FIG. 3, one or more engagement features 655 are disposed on the base surface 652, opposite the inkpad 600. The one or more engagement features 655 can have a dovetail arrangement adapted to be slidingly received by corresponding one or more engagement features 148 disposed on the top member 140. Other engagement configurations between the inkpad housing 650 and the base 100 may also be constructed. This arrangement permits the inkpad 600 to be selectively coupled with the stamp tool 10 or removed for storage or replacement.

The stamp tool 10 is intended for substantially self-inking operation. The inkpad 600 is constructed from materials known in the art to accommodate ink adapted for a stamp and to provide substantially uniform distribution of ink over the entirety of the stamp surface area. As previously described, the inkpad 600 is readily disengaged from the stamp tool 10, permitting efficient operation of the stamp tool 10 with different instances of the inkpad 600 accommodating inks of various colors and or ink types.

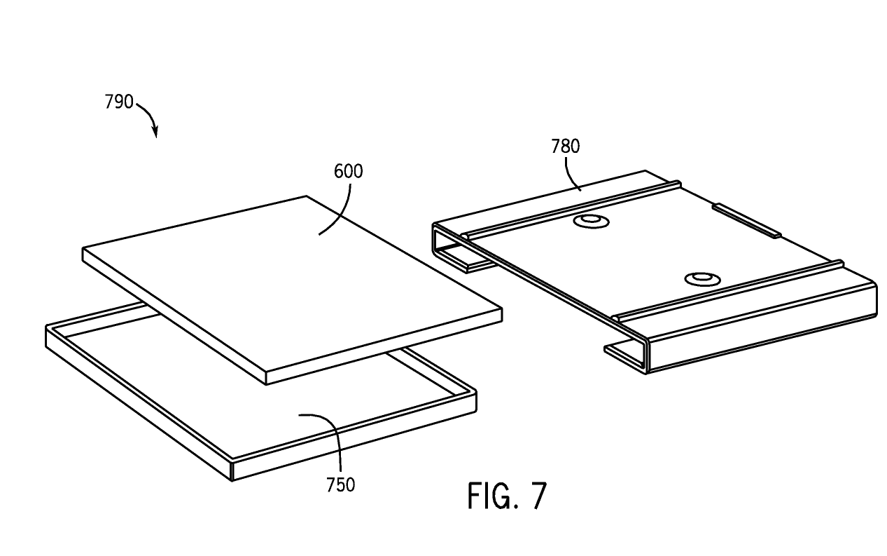

As shown in FIGS. 6A, 6B, and 6C, a inkpad cover 680 may be provided to selectively couple with the inkpad housing 650 to form an inkpad assembly 690 that substantially surrounds the inkpad 600. The inkpad cover 680 may comprise a five-sided box configured to nest with the inkpad housing 650. The inkpad housing 650 and the base 100 may be configured to permit engagement of the inkpad cover 680 while the inkpad housing 650 is operatively coupled to the stamp tool 10. Alternatively, the inkpad cover 680 may be engaged after the inkpad housing 650 is decoupled from the stamp tool 10. An alternative, inkpad assembly 790 is shown in FIG. 7. The inkpad assembly 790 comprises an inkpad 600 disposed at least partially within an inkpad base 750 and a inkpad cover 780 that is slidingly engageable with the inkpad base 750.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described to explain the principles of the present invention and its practical application to enable one skilled in the art to utilize the present invention in various embodiments and with various modifications as are suited to the particular use contemplated.

What is claimed is:

1. A hand stamp tool for placing a stamp on a surface, comprising:
a base orientable on a surface to receive a stamp, the base including one or more of a carriage guide;
a carriage operatively connected to the base, the carriage is configured for sliding translation and rotating in relation to the carriage guide, and the carriage is selectively orientable between an inking orientation and a stamping orientation;
an inkpad operatively connected to the base; and
a stamp operatively connected to the carriage,
wherein the stamp is engageable with the inkpad when the carriage is in the inking orientation, wherein the stamp is engageable with the surface when the 11 carriage is in the stamping orientation, and wherein the stamp is selectively adherable to the carriage.

2. The hand stamp tool of claim 1, wherein the stamp is selectively adherable to a substantially flat surface disposed on the carriage.

3. The hand stamp tool of claim 1, wherein the stamp is selectively adherable to the carriage by way of an electrostatic attraction between the stamp and the carriage.

4. The hand stamp tool of claim 1, wherein the stamp comprises a stamp plate and at least one stamp sheet, wherein the stamp plate is operatively connected to the carriage, and wherein the at least one stamp sheet is selectively adherable to the stamp plate.

5. The hand stamp tool of claim 4, wherein the at least one stamp sheet is selectively adherable to the stamp plate by way of electrostatic attraction between the at least one stamp sheet and the stamp plate.

6. The hand stamp tool of claim 1, further comprising an inkpad housing, wherein the inkpad housing is operatively connected to the base, and wherein the inkpad is operatively connected to the inkpad housing and disposed on the inkpad housing substantially opposite the base.

7. The hand stamp tool of claim 1, further comprising a cover operatively connected to the base, wherein the cover is selectively orientable between a relaxed orientation and an engaged orientation, and wherein operation of the cover transfers the carriage from an inking orientation to a stamping orientation.

8. The hand stamp tool of claim 7, further comprising a biasing member operatively connected to the cover and operatively connected to the base.

9. The hand stamp tool of claim 7, further comprising a locking member engageable with the base, the locking member selectively orientable between an unlocked orientation and a locked orientation, wherein in the locked orientation, the orientation of the cover is maintained.

10. The hand stamp tool of claim 6, further comprising an inkpad cover selectively engageable with the inkpad housing.

11. The hand stamp tool of claim 5, wherein the at least one stamp sheet further comprises a negative electrostatic charge, and wherein the stamp plate further comprises a positive electrostatic charge.

12. A hand stamp tool for placing a stamp on a surface, comprising:
a base orientable on a surface to receive a stamp, the base including one or more of a carriage guide;
a carriage operatively connected to the base, the carriage is configured for sliding translation and rotating in relation to the carriage guide, and the carriage is selectively orientable between an inking orientation and a stamping orientation;
an inkpad operatively connected to the base;
a stamp plate operatively connected to the carriage; and
at least one selectively adherable stamp sheet, the selectively adherable stamp sheet operatively couplable to a surface of the stamp plate substantially opposite the carriage,
wherein the stamp sheet is engageable with the inkpad when the carriage is in the inking orientation, and wherein the stamp is engageable with the surface when the carriage is in the stamping orientation.

13. The hand stamp tool of claim 12, wherein the at least one selectively adherable stamp sheet is selectively adherable to the surface of the stamp plate by way of electrostatic attraction between the at least one selectively adherable stamp sheet and the stamp plate.

14. The hand stamp tool of claim 12, further comprising an inkpad housing, wherein the inkpad housing is operatively connected to the base, and wherein the inkpad is operatively connected to the inkpad housing and disposed on the inkpad housing substantially opposite the base.

15. The hand stamp tool of claim 12, further comprising a cover operatively connected to the base, wherein the cover is selectively orientable between a relaxed orientation and an engaged orientation, and wherein operation of the cover transfers the carriage from an inking orientation to a stamping orientation.

16. The hand stamp tool of claim 15, further comprising a biasing member operatively connected to the cover and operatively connected to the base.

17. The hand stamp tool of claim 15, further comprising a locking member engageable with the base, the locking member selectively orientable between an unlocked orientation and a locked orientation, wherein in the locking orientation, the orientation of the cover is maintained.

18. The hand stamp tool of claim 13, further comprising an inkpad cover selectively engageable with the inkpad housing.

19. The hand stamp tool of claim 13, wherein the at least one selectively adherable stamp sheet further comprises a negative electrostatic charge, and wherein the stamp plate further comprises a positive electrostatic charge.

20. The hand stamp tool of claim 12, wherein the surface of the stamp plate is substantially flat.
